(19) United States
(12) Patent Application Publication
(10) Pub. No.: US 2026/0132225 A1
(43) Pub. Date: May 14, 2026

(54) METHOD FOR PRODUCING POWDERED SILYLATED CELLULOSE

(71) Applicants: Dow Silicones Corporation, Midland, MI (US); Dow Global Technologies LLC, Midland, MI (US)

(72) Inventors: Michael Telgenhoff, Midland, MI (US); David Williams, Midland, MI (US); Marc-Andre Courtemanche, Midland, MI (US); Beata Kilos, Midland, MI (US)

(21) Appl. No.: 19/118,384

(22) PCT Filed: Nov. 21, 2023
(86) PCT No.: PCT/US2023/080625

§ 371 Date: Apr. 4, 2025

Related U.S. Application Data
(60) Provisional application No. 63/432,715, filed on Dec. 15, 2022.

(51) Int. Cl. C08B 15/05

(52) U.S. Cl. CPC C08B 15/05

(57) ABSTRACT

A method for preparing a powdered silylated cellulose is disclosed. The method includes preparing a reaction product in the form of a powder that can be mixed and handled with conventional powder handling equipment.

### CROSS REFERENCE TO RELATED APPLICATIONS

This application claims the benefit of U.S. Provisional Patent Application Ser. No. 63/432,715 filed on 15 Dec. 2022 under 35 U.S.C. § 119 (e). U.S. Provisional Patent Application Ser. No. 63/432,715 is hereby incorporated by reference.

### FIELD

A method for producing a powdered silylated cellulose is provided. More particularly, the method for producing the powdered silylated cellulose can be utilized on a commercial production scale.

### INTRODUCTION

Current technologies for producing silylated cellulose are based on low volume yield slurry or solution processes. Some of these processes utilize high pressure, where the cellulose is in a slurry of liquified ammonia. Others utilize atmospheric pressure processes in high volumes of swelling solvents. These processes suffer from the drawbacks of requiring very large volumes of swelling solvents and recrystallization solvents and producing large volumes of resulting waste. Additionally, the space time yield of these processes are very low due to the volume requirements of the solvents. Therefore, these processes have not been commercially viable for larger scale usage.

U.S. Pat. No. 4,320,692 to Green discloses a method for the preparation of trimethylsilyl cellulose ethers, which comprises reacting cellulose with hexamethyldisilazane in the presence of a small quantity of catalyst. In the preferred method of carrying out the process, the reaction temperature is maintained between about 100° C. and about 135° C. At temperatures below 100° C. the reactions were found to be so slow that they were impractical and at temperatures above 135° C. the reactions were found to be very erratic.

There is an industry need for a more volume efficient process to prepare silylated cellulose. It would be desirable also for the process to operate at ambient pressures and/or utilize less solvent than existing processes.

### SUMMARY

A method for preparing a silylated cellulose is provided herein. The method comprises:
1) mixing starting materials comprising: A) a cellulose, B) a polar aprotic swelling solvent, C) a catalyst, and optionally a first portion of D) a silylating agent, thereby preparing E) a powdered intermediate; and
2) continuously or intermittently adding to E) the powdered intermediate, D) the silylating agent.

### DETAILED DESCRIPTION

More particularly, the method for preparing the silylated cellulose introduced above comprises:
1) mixing starting materials comprising
   A) a cellulose comprising repeating monomeric units and having >2.5 hydroxyl groups per monomeric unit,
   B) a polar aprotic swelling agent,
   C) a catalyst, and
   optionally D) a silylating agent comprising a silyl amine having a silicon-nitrogen moiety;
   wherein D) the silylating agent is added in an amount sufficient to provide an amount of silyl groups 0 to <50 mol % of hydroxyl groups of A) the cellulose, thereby forming E) a powdered intermediate; and
2) continuously or intermittently adding to E) the powdered intermediate, an amount of D) the silylating agent over a time period >2 hours; wherein total amount of D) the silylating agent added in steps 1) and 2) is >80 mol % to <200 mol %, alternatively >80 mol % to <150 mol %, based on the amount of hydroxyl groups of starting material A) the cellulose; thereby forming a powdered reaction product comprising the silylated cellulose.

In step 1), the amount of D) the silylating agent added in step 1) may be 0. Alternatively, in step 1) a first portion of D) the silylating agent sufficient to provide an amount of silyl groups >0 to <50 mol %, alternatively 0.01 mol % to 49 mol %, alternatively 30 mol % to 45 mol %, of hydroxyl groups of A) the cellulose may be used. In this instance, the powdered intermediate prepared in step 1) is a powdered reaction product comprising a partially silylated cellulose. Without wishing to be bound by theory, it is thought that if 50 mol % or more of D) the silylating agent is added at once in step 1), the reaction product comprising the partially silylated cellulose will be difficult to handle. However, it may be beneficial to add at least 30 mol % of D) the silylating agent in step 1) to minimize overall processing time. Alternatively, the amount of silylating agent added in step 1) may be at least 30 mol %, alternatively at least 34 mol %, alternatively at least 35 mol %; while at the same time the amount of the silylating agent may be <50 mol %, alternatively up to 45 mol %, alternatively up to 42 mol %, and alternatively up to 40 mol %, with respect to the hydroxyl groups of A) the cellulose. (For example, the molar ratio of silyl groups of starting material D) to COH groups of starting material A), the Si/COH ratio may be >0 to <0.50, alternatively 0.30 to 0.45, alternatively 0.34 to 0.42, alternatively 0.35 to 0.40.)

Steps 1) and 2) may be performed in a reactor, such as a batch vessel with a jacket for heating and cooling and an agitator for mixing. The type of reactor is not critical and may be any reactor suitable for mixing liquids and powders. The temperature in steps 1) and 2) may be 30° C. to 150° C., alternatively 50° C. to 85° C., alternatively 50° C. to 80° C., and alternatively 55° C. to 80° C. The pressure in steps 1) and 2) may be 730 mmHg (97 kPa) to 790 mmHg (105 kPa), alternatively 750 mmHg (100 kPa) to 770 mmHg (103 kPa).

In step 2), the feed rate of D) the silylating agent may be defined as any aliquot or continuous flow control that is >0 to <20 mol % of stoichiometry of the silylating agent loaded in a period >24 min to 500 minutes on a moving average basis over any two aliquots. One skilled in the art would understand how to feed at this rate using aliquots or continuous flow based on the description herein and the examples, below. Without wishing to be bound by theory, it is thought that using this feed rate in step 2) causes the reaction product comprising the silylated cellulose to form a powder that can be handled with conventional solids handling equipment and avoids formation of a paste or solid that cannot be mixed or removed from the reactor. Without wishing to be bound by theory, it is thought that if the entire balance (e.g., of ≥50 mol %) of D) the silylating agent is added at once in step 2), the reaction product comprising the silylated cellulose will be difficult to handle. Therefore, the continuous or intermittent feed rate described above is used in step 2) to maintain the reaction product as a powder. In step 2), a total amount of D) the silylating agent added in steps 1) and 2) is >80 mol % to <200 mol % based on the amount of hydroxyl groups of starting material A) the cellulose.

The method may optionally further comprise one or more additional steps. For example, the method may further comprise drying A) the cellulose before step 1). Commercially available cellulose may comprise adsorbed water. To minimize by-product formation, the cellulose may be dried to remove at least some of the water. Drying may be performed by any convenient means, such as exposing the cellulose to heat and/or reduced pressure or a flow of inert gas.

The method may optionally further comprise adding F) a solvent that differs from B) the polar aprotic swelling agent, for example, during or before step 1). Alternatively, the method may further comprise an additional step comprising: dissolving C) the catalyst in one or both of B) the polar aprotic swelling agent and F) the solvent, before step 1) to form a catalyst solution. The resulting catalyst solution may be mixed with A) the cellulose before step 1) (e.g., before adding any silylating agent into the reactor). For example, the catalyst solution may be mixed with A) the cellulose for at least 10 minutes, alternatively at least 15 minutes; while at the same time the catalyst solution may be mixed with A) the cellulose for up to 1 hour, before adding a first portion of D) the silylating agent. When used. F) the solvent may be present in an amount of >0 to 15 times the weight of C) the catalyst, alternatively >0 to 12 times the weight of the catalyst. Alternatively, the method may be solventless, in which F) the solvent is not used.

Alternatively, the method may further comprise an additional step comprising: forming C) the catalyst by a method comprising reacting a portion of D) the silylating agent with an acid ex-situ. Optionally F) the solvent may be used to facilitate combining the D) the silylating agent and the acid. When this step is added to the method, the silylating agent used for forming the catalyst may be, but is not limited to, a silazane as described below for starting material D). The silazane selected for forming the catalyst may be the same as, or different from, starting material D) used in step 1) to perform the silylation reaction. This step may be performed via any convenient means such as mixing, e.g., at RT and ambient pressure.

The method may optionally further comprise an additional step comprising reducing pressure on the powdered intermediate after step 1) and before step 2). The pressure may be, for example, ≤400 mmHg, alternatively ≤200 mmHg, and alternatively >0 to 100 mmHg. Alternatively, when D) the silylating agent is added in step 1), then reducing pressure on the powdered reaction product comprising partially silylated cellulose may be performed, e.g., to remove by-products.

The method may optionally further comprise step 4): washing the powdered silylated cellulose by combining the powdered silylated cellulose and G) a washing solvent, thereby removing residual polar aprotic swelling agent, catalyst, and/or solvent, and/or by-products that may be present. The washing solvent is not specifically restricted; however, the washing solvent may be a low boiling, polar solvent capable of dissolving residual starting materials and/or by-products without significantly solubilizing the silylated cellulose, which may be used for ease of evaporation from the silylated cellulose product. Washing in step 4) may be performed by any convenient means such as combining the washing solvent and the powdered silylated cellulose produced as described above in the reactor used in step 1) or in an agitated slurry vessel, and then draining the solvent after a sufficient time. The washing step can be repeated as many times as necessary, such as 1 to 10 times.

The method may optionally further comprise step 5): removing G) the washing solvent by any convenient means, such as filtering, heating, reduced pressure, and/or by purging with a gas, e.g., air or an inert gas such as nitrogen.

The resulting product is a pure silylated cellulose that was produced with low waste and high volume efficiency. The silylated cellulose produced by the method has a DS of alternatively 2.0 to 3.0, alternatively 2.2 to 3.0, alternatively 2.5 to 3.0, alternatively 2.6 to 3.0, and alternatively 2.8 to 3.0.

The starting materials used herein will be described in further detail, below.

### A) Cellulose

Starting material A), the cellulose used in the method described above, has >2.5 to 3, alternatively 3, hydroxyl groups per repeating monomeric unit in the molecule. Cellulose is a polymer of β(1→4) linked D-glucose repeating monomeric units. Cellulose may have 200 or more repeating monomeric units per molecule. Alternatively, cellulose may have at least 200, alternatively at least 300, alternatively at least 400, alternatively at least 500, alternatively at least 600, and alternatively at least 700 repeating monomeric units; while at the same time, the cellulose may have up to 10,000, alternatively up to 9,000, alternatively up to 8,000, alternatively up to 7,000, alternatively up to 6,000, alternatively up to 5,000, and alternatively up to 4,000 repeating monomeric units per molecule. Alternatively, the cellulose may have 200 to 10,000; alternatively 400 to 8,000 repeating monomeric units, per molecule.

The type of cellulose may be, for example, microcrystalline cellulose or pulp cellulose. Sources of cellulose include, but are not limited to, cotton linters, pine, and tunicin (animal derived cellulose). Cellulose is commercially available from various sources.

### B) Polar Aprotic Swelling Agent

Starting material B) used in the method described above is a polar aprotic swelling agent. Examples of suitable polar aprotic swelling agents include N-methyl pyrrolidone (NMP), N-dimethylacetamide (DMAc), dimethyl sulfoxide (DMSO), dimethyl sulfone, propylene carbonate, pyridazine, dimethylformamide (DMF), ethylene carbonate, sulfolane, tetrahydrothiophene-1-oxide, and hexamethylphosphoramide (HMPA).

Starting materials A) and B) are used in amounts such that a weight ratio of B) the polar aprotic swelling agent: A) the cellulose is <3:1, alternatively <1:1, alternatively <0.3:1 (B: A ratio). Alternatively, B: A ratio may be at least 0.1:1, alternatively 0.11:1, alternatively 0.12:1, alternatively 0.13:1, alternatively 0.14:1, alternatively 0.15:1, while at the same time the B: A ratio may be up to <0.3:1, alternatively 0.29:1, alternatively 0.28:1, alternatively 0.27:1, alternatively 0.26:1.

### C) Catalyst

Starting material C) in the method described above is a catalyst capable of catalyzing reaction of a hydroxyl group of A) the cellulose and a silicon-nitrogen (Si—N) moiety of D) the silylating agent. Examples of suitable catalysts include ammonium salts such as ammonium chloride, ammonium trifluoroacetate, or ammonium triflate; saccharin; a sulfonic acid such as methane sulfonic acid, p-toluene sulfonic acid, or trifluoromethane sulfonic acid (triflic acid); trifluoroacetic acid; trimethylsilyl chloride; or a combination thereof. Alternatively, the catalyst may be selected from the group consisting of ammonium chloride, ammonium trifluoroacetate, or saccharin. Alternatively, the catalyst may be selected from the group consisting of ammonium chloride or ammonium trifluoroacetate. Alternatively, the catalyst may comprise (or may be) ammonium trifluoroacetate.

The catalysts can be utilized by multiple methods those skilled in the art would understand. These could be adding C) the catalyst (such as ammonium trifluoroacetate) directly to the reactor, or dissolving C) the catalyst in B) the polar aprotic swelling agent or F) the solvent before adding the resulting catalyst solution to the reactor. Alternatively, C) the catalyst could be formed by pre-mixing certain silylating agents, such as a silazane or other silyl amines (as described below for starting material D), with an acid such as trifluoroacetic acid or triflic acid and then loading the resulting mixture containing a catalytic silyl ammonium salt to the reactor.

The amount of catalyst depends on various factors including the species of catalyst and temperature selected. However, the amount of catalyst may be at least 0.01 weight %, alternatively at least 0.1 weight %, alternatively at least 0.3 weight %, while at the same time the amount of catalyst may be up to 5 weight %, alternatively up to 4 weight %, alternatively up to 3 weight %, and alternatively up to 2 weight %; alternatively the amount of catalyst may be 0.1 weight % to 5 weight %, alternatively 0.3 weight % to 2 weight %, based on combined weights of starting materials A), B), C), and D) used in the method.

### D) Silylating Agent Having an Si—N Moiety

Starting material D) in the method described above is a silylating agent comprising a silyl amine having a silicon-nitrogen (Si—N) moiety. The Si—N moiety is reactive with the hydroxyl groups of A) the cellulose. The silylating agent may be selected from a silazane, an aminosilane, or a combination thereof. For example, the silazane can be a disilazane of formula

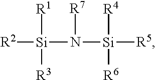

where R¹, R², R³, R⁴, R⁵, R⁶, and R⁷ are each independently selected from the group consisting of H, alkyl groups of 1 to 18 carbon atoms, and alkenyl groups of 2 to 18 carbon atoms. Suitable alkyl groups include methyl, ethyl, propyl and butyl; alternatively methyl ethyl and propyl. Suitable alkenyl groups include vinyl, allyl and hexenyl. Examples of suitable disilazane include 1,1,1,3,3,3-hexamethyldisilazane (HMDZ), 1,3-ethyl-1,1,3,3-tetramethyldisilazane; 1,3-dipropyl-1,1,3,3-tetramethyldisilazane; 1,3-dibutyl-1,1,3,3-tetramethyldisilazane; 1,3-divinyl-1,1,3,3-tetramethyldisilazane; 1,3-diallyl-1,1,3,3-tetramethyldisilazane; 1,3-dibutenyl-1,1,3,3,-tetramethyldisilazane; and 1,3-hydrido-1,1,3,3-tetramethyldisilazane.

Alternatively, the silylating agent may be an aminosilane, which may have formula: R^{N}ₓSiR⁸₄₋ₓ, where each R^{N} is an amino-functional group bonded to silicon via the nitrogen atom, and each R⁸ is independently selected from the group consisting of H, an alkyl group of 1 to 18 carbon atoms, and an alkenyl group of 2 to 18 carbon atoms, as described above for R¹, where subscript x is 1 to 3. R^{N} may have formula —NR⁹₂, where each R⁹ is independently selected from the group consisting of H, alkyl groups of 1 to 18 carbon atoms, or an aryl group of 6 to 18 carbon atoms.

Aminosilanes are exemplified by tris(dimethylamino) silane, bis(diisopropylamino) silane, (N,N-dimethylamino)trimethylsilane, trimethyl(amino) silane {H₂N—Si(CH₃)₃}, triethyl(amino)silane {H₂N—Si(CH₂—CH₃)₃}, tripropyl(amino) silane {H₂N—Si(C₃H₇)₃}, tributyl(amino) silane {H₂N—Si(C₄H₉)₃}; dimethylethyl(amino) silane; dimethylbutyl(amino) silane; trivinyl(amino) silane; dibutylethyl(amino) silane; tri (1-butenyl) (amino) silane; or triaryl(amino) silane. Suitable aminosilanes are known in the art and are commercially available from, e.g., Sigma-Aldrich, Inc. of St. Louis, Missouri, USA, or Gelest Inc. of Morrisville, Pennsylvania, USA.

Starting material D), the silylating agent, may be any one of the silazanes and/or aminosilanes described above. Alternatively, D) the silylating agent may be two or more silazanes, two or more aminosilanes, or a combination of a silazane and an aminosilane. Starting material D) the silylating agent is used in an amount sufficient to provide a molar ratio of Si—N moieties of D) the silylating agent: hydroxyl groups of A) the cellulose of >0.67:1 to 4:1 (D^{Si}:A^{OH} ratio). Alternatively, the D^{Si}:A^{OH} ratio may be 0.7:1 to 3.5:1, alternatively 0.8:1 to 3.0:1, alternatively 0.9:2.5:1, alternatively 1:1 to 2.0:1, alternatively 1.15:1 to 1.98:1, and alternatively 1.3:1 to 1.4:1.

### F) Solvent

Starting material F) used in the method described above is an optional solvent, which differs from B) the polar aprotic swelling agent. The solvent is not particularly restricted and may be any solvent capable of dissolving or dispersing C) the catalyst with one or more of the other starting materials. For example, the solvent may comprise an aliphatic hydrocarbon such as hexane, an aromatic hydrocarbon such as toluene or xylene, a halogenated hydrocarbon such as carbon tetrachloride, or an ether such as tetrahydrofuran.

The amount of solvent depends on various factors including the type and amount of catalyst selected. However, the amount of solvent may be >0 to 15 times the weight of C) the catalyst, alternatively up to 12 times the weight of the catalyst. Without wishing to be bound by theory, it is thought that it is desirable to minimize the amount of solvent for volume efficiency.

### G) Washing Solvent

Starting material G) in the method described herein is an optional washing solvent that may be used to remove residual starting materials and/or by-products from the silylated cellulose produced by the method. The washing solvent may be different from starting materials B) and F), described above. Examples of suitable washing solvents include water, a ketone such as acetone, monohydric alcohols such as methanol or ethanol; alternatively acetone. Without wishing to be bound by theory, it is thought that a ketone such as acetone may effectively remove both polar and non-polar residuals while being easy to remove from the silylated cellulose with reduced pressure.

### Methods of Use

The silylated cellulose prepared as described herein may be used in various end use applications. For example, the silylated cellulose may be used instead of the cellulose derivative described in U.S. Pat. No. 10,851,180 in optical films for image display devices. Alternatively, the silylated cellulose prepared as described above may be used as a thickening polymer in a personal care application (such as a cosmetic formulation or a sun care formulation), e.g., in addition to or instead of the silylated cellulose polymer disclosed in PCT Patent Publication WO/2022/066591.

### EXAMPLES

These examples are provided to illustrate the invention to one skilled in the art and are not to be construed to limit the scope of the invention set forth in the claims. Starting materials used in the examples are summarized below in Table 1.

TABLE 1
Starting Materials

| Starting Material | Description | Source |
|---|---|---|
| A1 | Microcrystalline cellulose | Avicel PH-101 from IFF |
| A2 | Pulped cellulose | Ground E60 From |
| | | Georgia Pacific |
| B1 DMSO | Dimethyl sulfoxide | Sigma-Aldrich |
| C1 NH₄Cl | Ammonium chloride | Sigma-Aldrich |
| D1 HMDZ | Hexamethyldisilazane | Dow |
| F1 | Acetone | Oakwood Chemicals |

### Example 1

In this Example 1, cellulose was silylated in a Sigma Blade style mixer (reactor) by loading 236.2 grams microcrystalline cellulose, then loading a pre-dissolved solution of 65.4 grams DMSO and 5.7 grams NH₄Cl and mixing for 30 minutes. 130.3 grams of HMDZ (0.37 Molar Si:COH) were loaded to the reactor at ambient temperature and heated to 53° C. and then held for one hour at temperature. The mixture maintained a consistency like a wet powder to this point. Vacuum was then pulled on the reactor to <200 mmHg for 15 minutes until condensate stopped in the dry ice vacuum trap. Vacuum was then broken with nitrogen and the reaction was continued with aliquots of HMDZ loaded over time. 182.7 grams of HMDZ (0.52 Molar Si:COH) were loaded in ˜60 gram aliquots every 30 minutes. The material in the reactor maintained a free flowing consistency as a wet powder throughout this time. Vacuum was then pulled on the reactor to <200 mmHg for 30 minutes. Vacuum was then broken with nitrogen and the reaction was continued with aliquots of HMDZ loaded over time. An additional 135.1 g of HMDZ (0.38 Molar Si:COH) were loaded in four ˜equal aliquots every 40 minutes for a total Molar Si:COH ratio of 1.27. At each addition, the material would take on the consistency of a free flowing wet powder and slowly convert to a free flowing dry powder over ˜20 minutes. After the last addition, the reactor was held at temperature for one hour. Vacuum was then pulled on the reactor to <200 mmHg and held ˜45 minutes. The reactor was cooled, and 527.2 grams of resulting crude product was recovered. The resulting silylated cellulose powder had a DS of 3.0

### Example 2

In this Example 2, cellulose was silylated in a Sigma Blade style mixer by loading 235 grams pulped cellulose, then loading a pre-dissolved solution of 64.7 grams DMSO and 5.68 grams NH₄Cl and mixed for 30 minutes. 140 grams of HMDZ (0.4 Molar Si:COH) were loaded to the reactor and then heated to 50° C. and held for one hour. At this time, vacuum was pulled to <200 mmHg to strip liquid from the reactor. Then an additional 217 grams of HMDZ (0.62 Molar Si:COH) was loaded in equal increments over seven additions, each 15 minutes apart. At this time, vacuum was pulled to <200 mmHg to strip liquid from the reactor. Then an additional 85 grams of HMDZ (0.24 Molar Si:COH) was loaded in equal increments over six additions, each 20 minutes apart for a total Molar Si:COH ratio of 1.26. The reactor was then held at 50° C. for one hour. The material in the reactor was a free flowing powder throughout the feeds and vacuum strips. After holding at temperature, vacuum was pulled on the reactor <200 mmHg. After vacuum was achieved, the reactor was heated at 90° C. for 30 minutes ensuring no more liquid was dripping in the vacuum flask. 513.27 grams of crude product was recovered. The crude product was washed with acetone in a Büchner funnel and then dried in a pan overnight. The resulting silylated cellulose powder had a DS of 2.0.

### Example 3—Commercial Scale Run

In this Example 3, cellulose was silylated in a Littleford Plow style mixer by loading 1735 grams microcrystalline cellulose, then loading a pre-dissolved solution of 467.5 grams DMSO and 41.3 grams NH₄Cl and mixing for 30 minutes. 870 grams of HMDZ (0.34 Molar Si:COH) were fed continuously through a spray nozzle using a pressure pot and needle valve over 34 minutes while the reactor was held at 65° C. The mixture was then held at temperature and mixing for one hour. At this time, vacuum was pulled <50 mmHg and held for 15 minutes. Then an additional 894.6 grams of HMDZ (0.34 Molar Si:COH) were fed continuously through a spray nozzle using a pressure pot and needle valve over 126 minutes while the reactor was held at 65° C. The HMDZ rate was then slowed and an additional 1,490 grams of HMDZ (0.58 Molar Si:COH) were fed continuously through a spray nozzle using a pressure pot and needle valve over 317 minutes while the reactor was held at 65° C. for a total Molar Si:COH ratio of 1.26. The reactor was then held at 65° C. for 29 minutes. The material in the reactor was a fine flowing powder throughout the reaction and feeds. After holding at temperature, vacuum was pulled on the reactor <50 mmHg. After vacuum was achieved, the reactor was heated to 90° C. for 60 minutes ensuring no more liquid was dripping in the vacuum flask.

After vacuum stripping the crude product, a portion of the resulting material was removed (1055 grams) from the reactor. Then 8000 grams of cold acetone (3° C.) was loaded to the reactor with the remaining crude silylated cellulose and the slurry was occasionally mixed (60 RPM for three times at 2-5 minutes over 33 minutes) while maintaining 25° C. slurry temperature. The bottom port was then opened and the material was drained through a bag filter to capture the solids. The solids were loaded back to the reactor and washed a second time. 6000 grams of acetone were loaded to the reactor and mixed with the plow at 60 RPM and the reactor at 25° C. for 31 minutes. The bottom port was then opened and the material was drained through a bag filter to capture the solids. 1350 grams of the silylated cellulose at this step were removed and set aside. The residual of the solids were loaded back to the reactor. 4000 grams of acetone were loaded to the reactor and mixed with the plow at 60 RPM for 31 minutes. The bottom port was then opened and the material was drained through the filter. The collected solids were loaded back to the reactor a final time. The residual powder was then mixed at 120 RPM while heating to 90° C. and pulling vacuum to −22 inHg. The vacuum drying step was held for 72 minutes. The product was then cooled and discharged from the plow mixer as a fine dry powder. The collected final dried product was 1300 grams of powdered silylated cellulose with a DS of 2.5.

### Example 4—Silylated Cellulose with TFAA·NH₃ Catalyst

In this Example 4, cellulose was silylated in a Sigma Blade style mixer by loading 249 grams microcrystalline cellulose, then loading a pre-dissolved solution of 68 grams DMSO and 10.43 grams ammonium trifluoroacetate and mixing for 15 minutes. 157 grams of HMDZ (0.42 Molar Si:COH) were loaded to the reactor and then heated to 65° C. and held for one hour. At this time, vacuum was pulled to <200 torr to strip liquid from the reactor. Vacuum was then broken with nitrogen. Then an additional 188 grams of HMDZ (0.51 Molar Si:COH) was loaded in equal increments over six additions, each 10 minutes apart. The material in the reactor stayed a fine dry powder throughout. Then an additional 140.5 grams of HMDZ (0.38 Molar Si:COH) was loaded in equal increments over seven additions, each 20 minutes apart for a total Molar Si:COH ratio of 1.31. The material in the reactor stayed a fine dry powder throughout. The reactor was then held at 65° C. for one hour. After holding at temperature, vacuum was pulled on the reactor <200 torr. After vacuum was achieved, the reactor was heated to 90° C. for 30 minutes ensuring no more liquid was dripping in vacuum flask. 579.02 grams of crude product was recovered. The material was washed 3× with acetone in a pressure filter and then dried overnight by purging through with nitrogen. The resulting silylated cellulose powder had a DS of 2.6.

### Example 5

In this Example 5, cellulose was silylated in a Littleford Plow style mixer by loading 1440 grams microcrystalline cellulose, then loading a pre-dissolved solution of 404 grams DMSO and 35.6 grams NH₄Cl and mixing for 35 minutes. 955 grams of HMDZ (0.44 Molar Si:COH) were fed continuously through a spray nozzle using a pressure pot and needle valve over 50 minutes while the reactor was held at 70° C. The mixture was then held at temperature and mixing for twenty minutes. At this time, vacuum was pulled <50 mmHg and held for 20 minutes. Then an additional 870 grams of HMDZ (0.40 Molar Si:COH) were fed continuously through a spray nozzle using a pressure pot and needle valve over 147 minutes while the reactor was held at 70° C. At this time, vacuum was pulled <50 mmHg and held for 10 minutes. Then an additional 910 grams of HMDZ (0.42 Molar Si:COH) were fed continuously through a spray nozzle using a pressure pot and needle valve over 127 minutes while the reactor was held at 70° C. for a total Molar Si:COH ratio of 1.27. The reactor was then held at 65° C. for 30 minutes. The material in the reactor was a dry powder throughout the reaction and feeds. After holding at temperature, vacuum was pulled on the reactor <50 mmHg. After vacuum was achieved, the reactor was heated to 80° C. for 13 minutes ensuring no more liquid was dripping in the vacuum flask.

1.6 kg of sample was divided into two equal parts. Both fractions were washed with acetone (1 L) on a coarse glass frit. For both fractions, the solids were ground to a powder using a laboratory blender and washed with 1 L of acetone again twice and filtered on a glass frit. The sample was left to dry standing in a fume hood for 24 h. The solids from both fractions were combined and washed with 1 L of acetone again twice and filtered on a glass frit. The sample was left to dry standing in a fume hood for 72 h. The resulting silylated cellulose powder had a DS of 2.7.

### Comparative Example 6—Bulk HMDZ Loaded Initially without Step 2)

For this comparative example 6, cellulose was silylated in a horizontal plow style mixer by loading 2.64 kg pulped cellulose, then loading a pre-dissolved solution of 740 g DMSO and 65.4 g NH₄Cl and mixed for 30 minutes. The mixer was heated to 90° C. When the internal temperature reached 68° C., 5.25 kg of HMDZ (1.33 Molar Si:COH) was loaded over 10 minutes. As the internal temperature reached 90° C. the hot oil system temperature was reduced to prevent internal temperatures from exceeding 90° C. The reactor was held at temperature for 1.5 hours; however, high amps were observed. When vacuum was pulled on the system, the agitators faulted and were unable to be started back up. Upon opening the mixer it was observed that the entire mixer volume was filled with a hardened foam-like material that needed to be manually cut out of the mixer. This example shows that when the method of the invention is not followed, and the silylating agent (HMDZ) was added all at once, a powdered silylated cellulose does not form. The hardened solid that forms is impractical to handle, and the method of silylating cellulose in this comparative example is not suitable for commercial scale production of silylated cellulose.

DS, or Degree of Substitution, is defined as the average number of hydroxyl groups per monomeric unit of cellulose that is silylated. DS is determined by ATR-FTIR, as follows. The degree of substitution, DS, of —SiR₃ in the silylated cellulose prepared by the method described herein was determined using techniques known in the art based on Attenuated Total Reflection-Fourier Transform Infrared Spectroscopy analyzing spectra peak areas calculated with MATLAB using the spectral parameters provided in Table 2 with the DS values determined as reported in Table 3.

TABLE 2

| | |
|---|---|
| Integration (cm⁻¹) | Baseline (cm⁻¹) |

| Species | Start | End | Start | End |
|---|---|---|---|---|
| —Si(CH₃)₃ | 1277 | 1220 | 1278 | 1219 |
| —OH | 3685 | 3033 | 3697 | 3040 |

TABLE 3
DS Values for Examples above.

| Sample | SiMe | CO | OH | [OH]/[Si] | DS | Si wt % | OH wt % |
|---|---|---|---|---|---|---|---|
| Ex. 1 (27) | 3.2 | 24.2 | 0 | 0 | 3.0 | 22.2% | 0.0% |
| Ex. 2 (29) | 2.8 | 22.7 | 1.8 | 0.32 | 2.0 | 18.2% | 5.8% |
| Ex. 3 (BP-6) | 1.4 | 11.7 | 0.3 | 0.12 | 2.5 | 20.5% | 2.4% |
| Ex. 4 (38) | 2.7 | 20.8 | 0.5 | 0.11 | 2.6 | 20.7% | 2.2% |
| EX. 5 (BP-5) | 2.6 | 20.3 | 0.3 | 0.06 | 2.7 | 21.3% | 1.3% |

### INDUSTRIAL APPLICABILITY

Without wishing to be bound by theory, it is thought that the method described herein can provide silylated cellulose with a DS ≥2, alternatively DS ≥2.5, alternatively ≥2.6 and alternatively DS ≥2 to 3.0. Examples 1 to 4 demonstrated that a silylated cellulose with a degree of substitution up to 3.0 was prepared by the method of this invention. Examples 1 to 4 and comparative example 5 showed that the method of this invention provided a benefit of providing the silylated cellulose in the form of a powder that is easy to transport in a method with good volume efficiency that did not require a solvent to be used during the silylation reaction. Furthermore, the method of this invention is suitable for commercial scale production of silylated cellulose. The examples above demonstrated that the method can produce a batch of silylated cellulose ≥500 g, alternatively ≥600 g, alternatively ≥1 kg, and alternatively ≥3 kg.

Without wishing to be bound by theory, it is thought that the method of this invention may provide a further benefit of minimizing or eliminating yellowing of the silylated cellulose produced by performing the silylation reaction at a temperature≤85° C.

### Definitions and Usage of Terms

All amounts, ratios, and percentages herein are by weight, unless otherwise indicated. The articles, ‘a’, ‘an’ and ‘the’ each refer to one or more unless otherwise indicated. The singular includes the plural unless otherwise indicated. The SUMMARY and ABSTRACT are hereby incorporated by reference. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III.

The abbreviations used herein have the definitions in Table 4.

TABLE 4
Abbreviations

| Abbreviation | Definition |
|---|---|
| ATR-FTIR | Attenuated Total Reflection - Fourier Transform Infra-Red |
| ° C. | Degree Celsius |
| DS | Degree of substitution |
| g | gram |
| h | hour |
| Kg or kg | kilogram |
| min | minute |
| RT | Room temperature of 23° C. ± 3° C. |

1. A method for making a powdered silylated cellulose, wherein the method comprises:
1) mixing starting materials comprising
A) a cellulose comprising repeating monomeric units and having >2.5 to 3 hydroxyl groups per monomeric unit,
B) a polar aprotic swelling agent,
wherein B) the polar aprotic swelling agent and A) the cellulose are used in amounts such that a weight ratio of B) the polar aprotic swelling agent: A) the cellulose is <3:1,
C) a catalyst, and
D) a silylating agent comprising a silyl amine having a silicon-nitrogen moiety;
wherein D) the silylating agent is added in step 1) in an amount sufficient to provide an amount of silyl groups >0 to <50 mol % of hydroxyl groups of A) the cellulose, thereby forming E) a powdered product comprising powdered partially silylated cellulose; and
2) continuously or intermittently adding to E) the powdered product, an amount of D) the silylating agent over a time period >2 hours; wherein a total amount of D) the silylating agent added in steps 1) and 2) is >80 mol % to <200 mol % based on the amount of hydroxyl groups of starting material A) the cellulose; thereby forming a powdered reaction product comprising the silylated cellulose.

2. The method of claim 1, where in step 1), the amount of D) the silylating agent is sufficient to provide 30 mol % to 45 mol % of hydroxyl groups of A) the cellulose.

3. The method of claim 2, further comprising reducing pressure on the powdered product comprising the powdered partially silylated cellulose before step 2).

4. The method of any one of claims 1 to 3, further comprising drying A) the cellulose before step 1).

5. The method of any one of claims 1 to 4, where B) the polar aprotic swelling agent and A) the cellulose are used amounts such that a weight ratio of B) the polar aprotic swelling agent: A) the cellulose is 0.1:1 to <0.3:1 (B: A ratio).

6. The method of any one of claims 1 to 5, where C) the catalyst is selected from saccharin, ammonium trifluoroacetate and ammonium chloride.

7. The method of claim 6, where C) the catalyst is ammonium trifluoroacetate.

8. The method of any one of claims 1 to 5, where the method further comprises: forming C) the catalyst by a method comprising reacting a silazane with an acid ex-situ.

9. The method of any one of claims 1 to 8, where steps 1) and 2) are performed at a pressure of a pressure of 730 mmHg (97 kPa) to 790 mmHg (105 kPa).

10. The method of any one of claims 1 to 9, where steps 1) and 2) are performed with heating at 50° C. to 85° C.

11. The method of any one of claims 1 to 10, further comprising step 3): reducing pressure after step 1) and before step 2) to ≤400 mmHg (53.3 kPa), thereby forming a powdered silylated cellulose.

12. The method of claim 11, further comprising step 4): washing the powdered silylated cellulose from 1 to 10 times by combining the powdered silylated cellulose and G) a washing solvent.

13. The method of claim 12, wherein G) the washing solvent is removed with heating, reduced pressure, and/or by purging with a gas.

14. The method of any one of claims 1 to 13, where the powdered silylated cellulose is produced in an amount of at least 500 g.

15. The method of any one of claims 1 to 14, where in step 2), feed rate of D) the silylating agent is any aliquot or continuous flow control that is >0 to <20 mol % of stoichiometry of the silylating agent loaded in a period >24 min to 500 minutes on a moving average basis over any two aliquots.
